(19) United States
(12) Patent Application Publication
(10) Pub. No.: US 2008/0111650 A1
(43) Pub. Date: May 15, 2008

(54) Coupling device with electro-magnetic compensation

(76) Inventors: Jen-I Kuo, Chiayii (TW); Jih-Hwa Lee, Taoyuan (TW); Joseph D. S. Deng, Taoyuan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/598,658

(22) Filed: Nov. 14, 2006

(51) Int. Cl. H01P 5/18

(52) U.S. Cl. 333/116

(57) ABSTRACT

A coupling device with electro-magnetic compensation is provided. The coupling device includes a first substrate having a first signal line on a top surface of the first substrate and a second substrate having a second signal line on a top surface of the second substrate connected together with a bottom surface of the first substrate wherein the second signal line couples with the first signal line by a plurality of electrical-conductive through holes. One side of the first signal line lies a capacitor device parallel connected to a ground and the capacitor device plays the role of adjusting the amount of return loss, isolation capacity, and coupling effect so as to have transmitting speeds in first and second signal lines remain substantially the same and superior high frequency characteristics.

### BACKGROUND OF THE INVENTION

### Background

1. Field of the Invention

The present invention relates to a coupling device, and more particularly, to a coupling device with electro-magnetic compensation with the use of a parallel-connected capacitor device to the ground for adjusting the amount of return loss and isolation and getting the amount of coupling effect and output to a level as expected in order to obtain a better high frequency characteristic.

2. Description of the Prior Art

Please refer to FIG. 10 where a prior art broadside coupler 5 includes an upper layer signal line 51 and a lower layer signal line 52 attached to substrates 53 and 54, respectively. The upper signal line 51 couples with the lower signal line 52 by a plurality of electrical conductive through holes 55. A medium layer (substrate) 53 is between the upper layer signal line 51 and the lower layer signal line 52. The prior art coupling device 5 further includes an input end 56, a coupling end 57, an output end 58, and an isolation end 59. FIG. 8A shows the result after having above mentioned ends measured and is indicative of inferior amount of return loss and isolation capacity with the amount of coupling effect and outputting not reaching to a level as anticipated.

The amount of coupling effect, return loss, and isolation capacity depend on the line width of the upper layer signal line 51 and the lower layer signal line 52 and the thickness of the medium layer between the upper layer signal line 51 and the lower layer signal line 52. For the sake of obtaining better return loss and isolation capacity, the change to the line width of the upper layer signal line 51 and the lower layer signal line 52 or the thickness of the medium layer between the upper layer signal line 51 and the lower layer signal line 52 is inevitable, which is not preferred here.

Furthermore, the coupling device 5 couples the signal of the upper layer signal line 51 with that of its lower layer counterpart 52 through the medium layer between 51 and 52 and as the result odd/even mode problems would arise and the transmitting speeds of signals in the upper layer signal line 51 and the lower layer signal line 52 are different, leading to the inferior high frequency characteristic.

### SUMMARY OF THE INVENTION

It is therefore a primary objective of the present invention to provide a coupling device with electro-magnetic compensation. With the use of a parallel-connected capacitor device, the present coupling device adjusts the amount of return loss and isolation capacity and makes the amount of coupling and output to reach to a level as anticipated. Furthermore, the present coupling device renders the consistency of signal transmitting speeds in two signal lines possible, achieving the goal of better high frequency characteristics.

In accordance with the claimed invention, a coupling device with electro-magnetic compensation includes a first substrate having a first signal line on a top surface of the first substrate, and a second substrate having a second signal line on a top surface of the second substrate connected together with a bottom surface of the first substrate wherein the second signal line is coupled with the first signal line by a plurality of electrical-conductive through holes, and one side of the first signal line lies a capacitor device parallel connected to a ground. The parallel-connected capacitor device could be either an open stub, a plurality of open stubs connected with others through wire bonding or ribbon bonding, or in the form of getting at least one capacitor connected to a grounded open stub.

It is an advantage of the present invention that with the setting of a parallel-connected capacitor device on one side or both sides of the signal line the present coupling device could have a superior isolation capacity and cut down the return loss while staying the coupling effect and amount of output at a level as expected and rendering the consistency of transmitting speeds in two signal lines possible in order to obtain a better high frequency characteristic.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a coupling device according to the present invention.

FIG. 2 is a top view of a first preferred embodiment according to the present invention.

FIG. 3 is a top view of a second preferred embodiment according to the present invention.

FIG. 4 is a top view of a third preferred embodiment according to the present invention.

FIG. 5 is another schematic diagram of a coupling device according to the present invention.

FIG. 6 is a top view of a fourth preferred embodiment according to the present invention.

FIG. 7 is a top view of a fifth preferred embodiment according to the present invention.

FIG. 8 is a top view of a sixth preferred embodiment according to the present invention.

FIG. 9A is a curve of the S-parameter of a coupling device according to the present invention.

FIG. 9B is a curve of the S-parameter of a coupling device according to the prior art.

FIG. 10 is a schematic diagram of a coupling device according to the prior art.

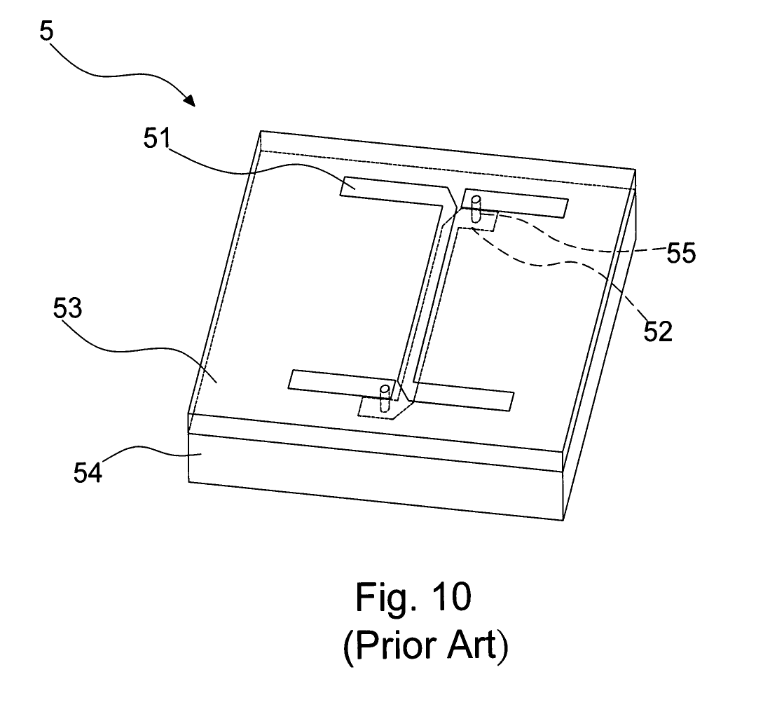

### DETAILED DESCRIPTION OF THE PREFERRED EMBODIMENT

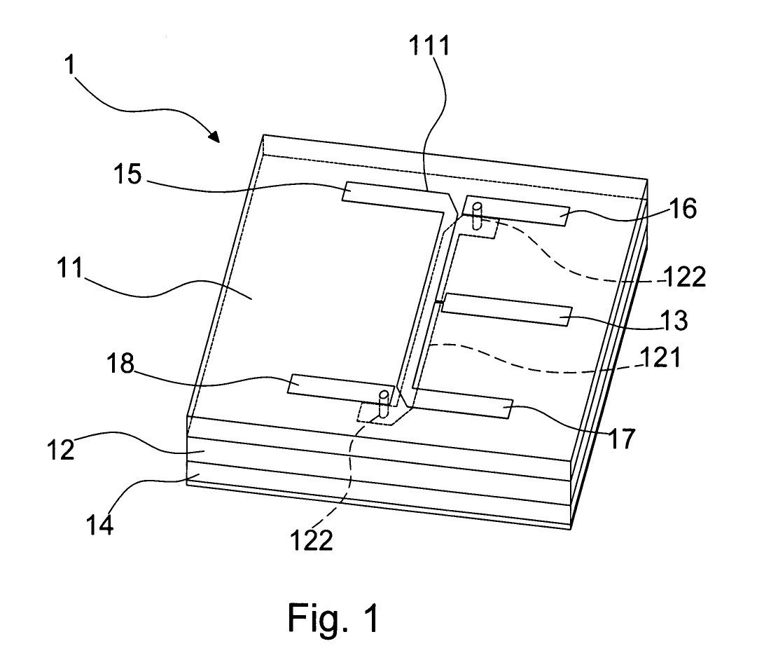

Please refer to FIG. 1 of a schematic diagram showing a coupling device 1 according to the present invention. The coupling device 1 includes a first substrate 11 having a first signal line 111 thereon, a second substrate 12 having a second signal 121 thereon, and a parallel-connected capacitor device 13. The first signal line 111 is on the top surface of the first substrate 11 and the bottom surface of the first substrate 11 attaches to the top surface of the second substrate 12 where lies the second signal line 121. The second signal line 121 couples with the first signal line 111 by a plurality of through holes 122 and the parallel-connected capacitor device 13 is placed beside the first signal line 111. The bottom surface of the second substrate 12 further connects to a multi-layer substrate 14 where other layout could be placed. The parallel-connected capacitor device 13 could be either an open stub, in the form of a plurality of open stubs connected with others by wire bonding or ribbon bonding, or a grounded capacitor device.

The first signal line 111 has four ends including an input end 15, a coupling end 16, an output end 17, and an isolation end 18. The coupling device according to the present invention 1 could get the amount of coupling effect, return loss, and the isolation capacity by measuring aforementioned four ends of the first signal line 111. The amount of the coupling effect, return loss, and isolation capacity depend on the length width of first and second signal lines 111 and 121, the thickness of medium layer between those two signal lines 111 and 121 (i.e., the thickness of the first substrate 11), and the parallel-connected capacitor device 13 and the area thereof.

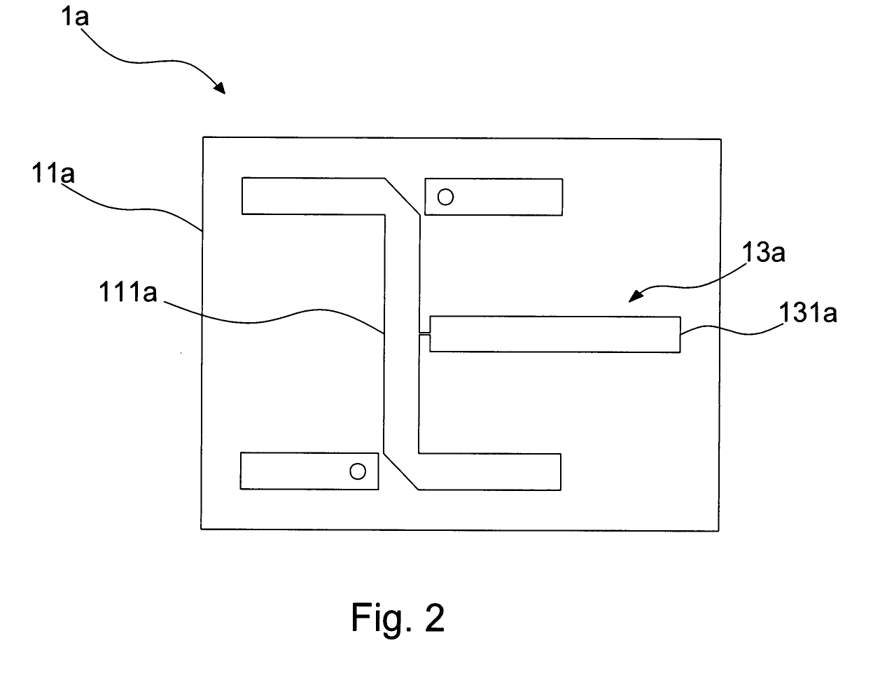

Please refer to FIG. 2 of a structure schematic diagram of the first preferred embodiment according to the present invention. A coupling device 1a includes a first substrate 11a having a first signal line 111a, a second substrate 12a (refer to FIG. 1) connected to the first substrate 11a and having a second signal line 121a (refer to FIG. 1 also), and a parallel-connected capacitor device 13a beside the first signal line 111a. The current preferred embodiment employs an open stub 131a as the parallel-connected capacitor device 13a and the area of the open stub affects the amount of the coupling effect, return loss, and the isolation capacity of the coupling device 1a. However, the use of an open stub as the parallel-connected capacitor device makes the change to the area of the open stub inconvenient where another new open stub must be replaced in order to make changes to the area of the open stub, leading to some inconvenience.

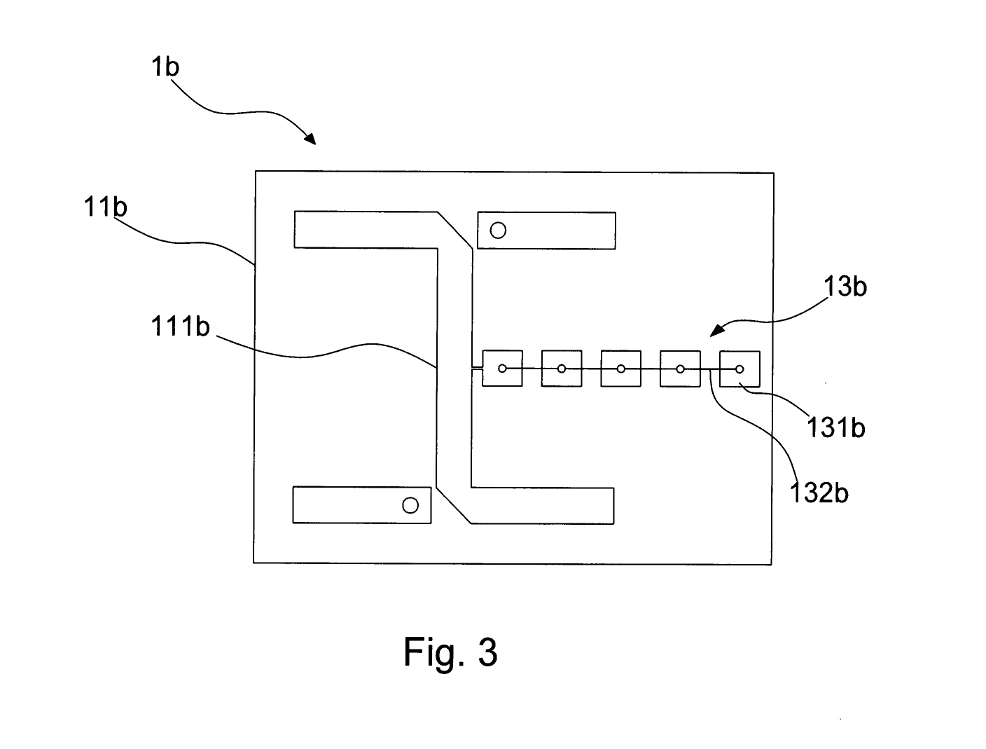

Please refer to FIG. 3 of a top view of the second preferred embodiment according to the present invention. A coupling device 1b includes a first substrate 11b having a first signal line 111b, a second substrate attached to the first substrate and having a second signal line (refer to FIG. 1), and a parallel-connected capacitor device to the ground 13b beside the first signal line 111b. In the current embodiment, the parallel-connected capacitor device to the ground 13b is in the form of a plurality of open stubs 131b interconnected with others through wire bonding or ribbon bonding, making the area of the parallel-connected capacitor device to the ground 13b adjustable without changing the entire open stub.

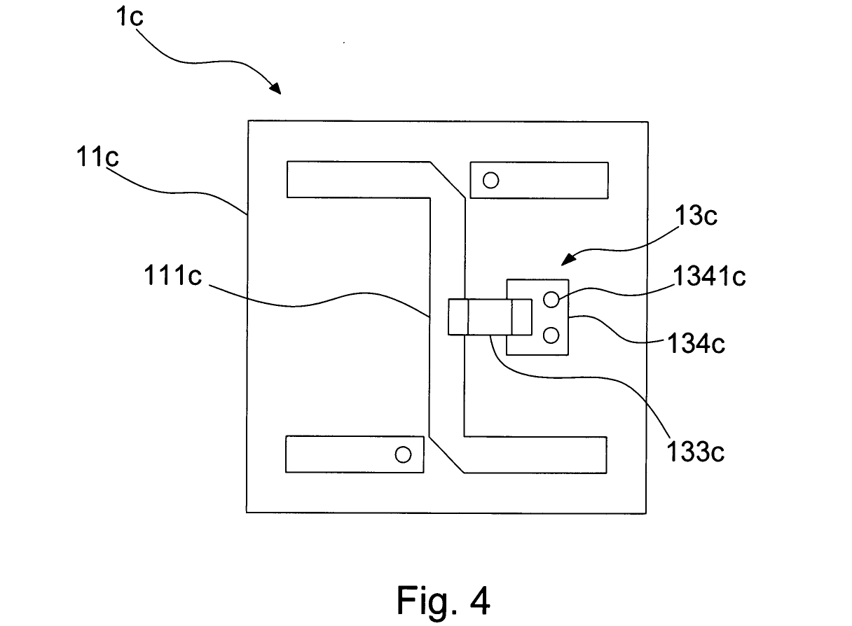

Please refer to FIG. 4 of a top view of a third preferred embodiment according to the present invention. A coupling device 1c includes a first substrate 11c having a first signal line 111c, a second substrate attached to the first substrate and having a second signal line (refer to FIG. 1), and a parallel-connected capacitor device to the ground 13c beside the first signal line 111c. The parallel-connected capacitor device to the ground 13c in the this preferred embodiment is in the form of having at least one capacitor 133c with one end attached to one side of the first signal line 111c and the other end connected to a grounded open stub 134c. The grounded open stub 134c has at least one through hole 1341c for the purpose of grounding. The coupling device 1c adjusts the value of the capacitor 133c so as to control the amount of the coupling effect, return loss, and isolation capacity of the coupling device 1c itself.

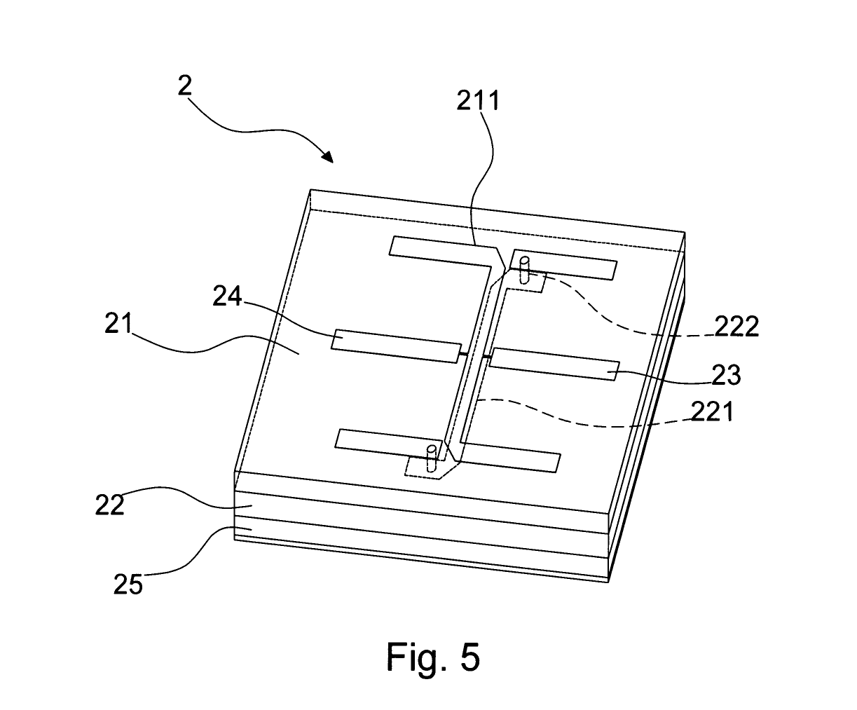

Please refer to FIG. 5 of another schematic diagram of a coupling device according to the present invention. A coupling device 2 includes a first substrate 21 having a first signal line 211, a second substrate 22 having a second signal line 221, a first parallel-connected capacitor device 23, and a second parallel-connected capacitor device 24. The bottom surface of the first substrate 21 connects to the top surface of the second substrate 22. The second signal line 221 couples with the first signal line by a plurality of through holes 222. The first parallel-connected capacitor device 23 and the second parallel-connected capacitor device 24 serving as the counterpart of the first parallel-connected capacitor device 23 in terms of the placement lie on each side of the first signal line 211, respectively. The bottom surface of the second substrate 22 connects to a multi-layer substrate 25 where other circuitry layout is placed. The first and second parallel-connected capacitor devices 23 and 24 both could be open stubs, a plurality of open stubs interconnected with others by wire bonding or ribbon bonding, or in the form of having at least one capacitor connected to a grounded open stub.

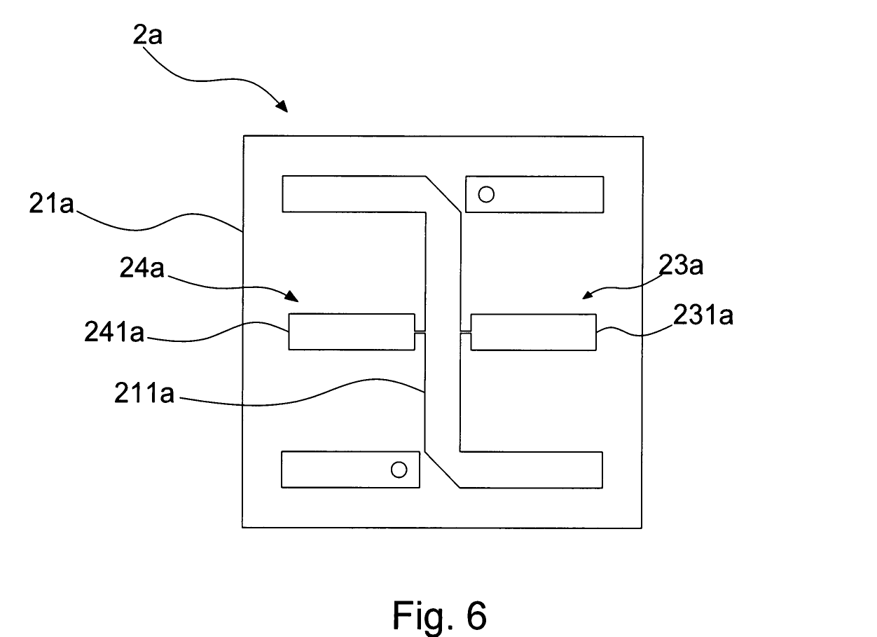

Please refer to FIG. 6 of a top view of a fourth preferred embodiment according to the present invention. A coupling device 2a includes a first substrate 21a having a first signal line 211a, a second substrate having a second signal line (refer to FIG. 5), a first parallel-connected capacitor device 23a, and a second parallel-connected capacitor device 24a on each side of the first signal line 211a. In the current embodiment, the first and second parallel-connected capacitor devices 23a and 24a are open stubs 231a and 241a, respectively, in order to save more space than the embodiment shown in FIG. 2. In FIG. 2, in the case that the open stub 131a takes more space the space of the whole coupling device 1a increases as the result. The present embodiment divides the open stub 131a in FIG. 2 into two pieces of open stubs 231a and 241a placed on each side of the first signal line 211a, for the purpose of limiting the size of the entire coupling device 2a.

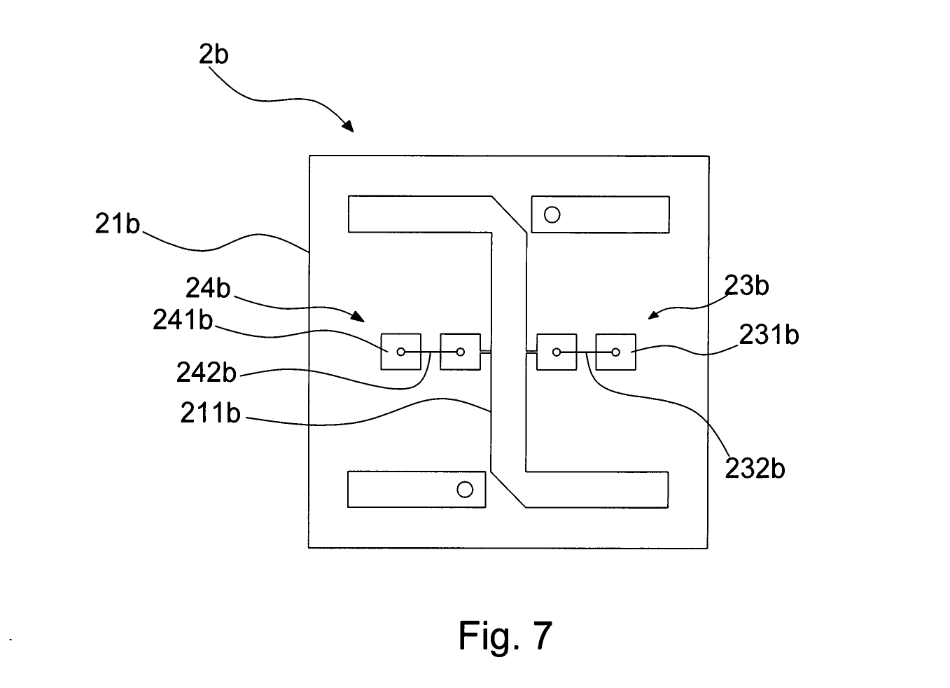

Please refer to FIG. 7 of a top view of a fifth preferred embodiment according to the present invention. A coupling device 2b includes a first substrate 21b having a first signal line 211b, a second substrate connected to the first substrate 21b and having a second signal line (refer to FIG. 5), and a first parallel-connected capacitor device 23b and a second parallel-connected capacitor device 24b placed on each side of the first signal line 211b, respectively. The first and second parallel-connected capacitor devices 23b and 24b are a plurality of open stubs 231b and 241b, respectively. Those open stubs 231b and 241b are interconnected with others through wire bonding or ribbon bonding. In doing so, at the time of adjusting the area of the first and second parallel-connected capacitor devices 23b and 24b only cutting down the number of those open stubs 231b and 241b is required, providing a viable alternative to the fourth preferred embodiment according to the present invention shown in FIG. 5.

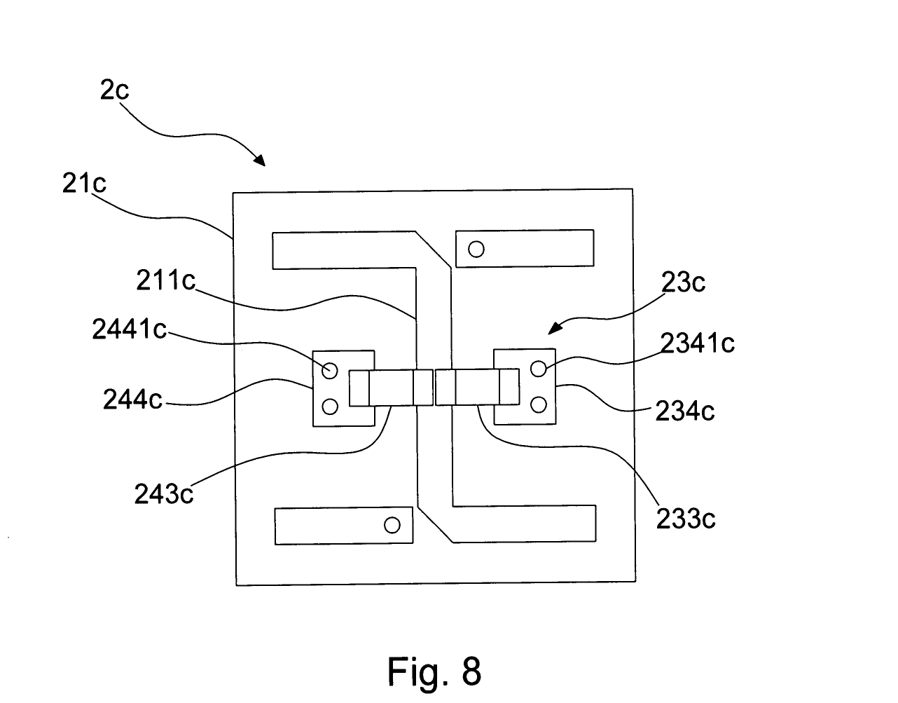

Please refer to FIG. 8 of a top view of a sixth preferred embodiment according to the present invention. A coupling device 2c includes a first substrate 21c having a first signal line 211c, a second substrate connected to the first substrate 21c and having a second signal line (refer to FIG. 5), and a first parallel-connected capacitor device 23c and a second parallel-connected capacitor device 24c placed on each side of the first signal line 211b, respectively. The first and second parallel-connected capacitor devices 23c and 24c are single capacitors 233c and 243c connected to grounded open stubs 234c and 244c. One end of each of capacitors 233c and 243c connects to the first signal line 211c while the other end of those capacitors 233c and 243c connects to grounded open stubs 234c and 244c. Those grounded open stubs 233c and 244c each has at lest one through hole 2341c and 2441c connected to the ground. The present preferred embodiment controls the value of capacitors 233c and 243c for controlling the coupling effect, the return loss, and the isolation capacity thereof.

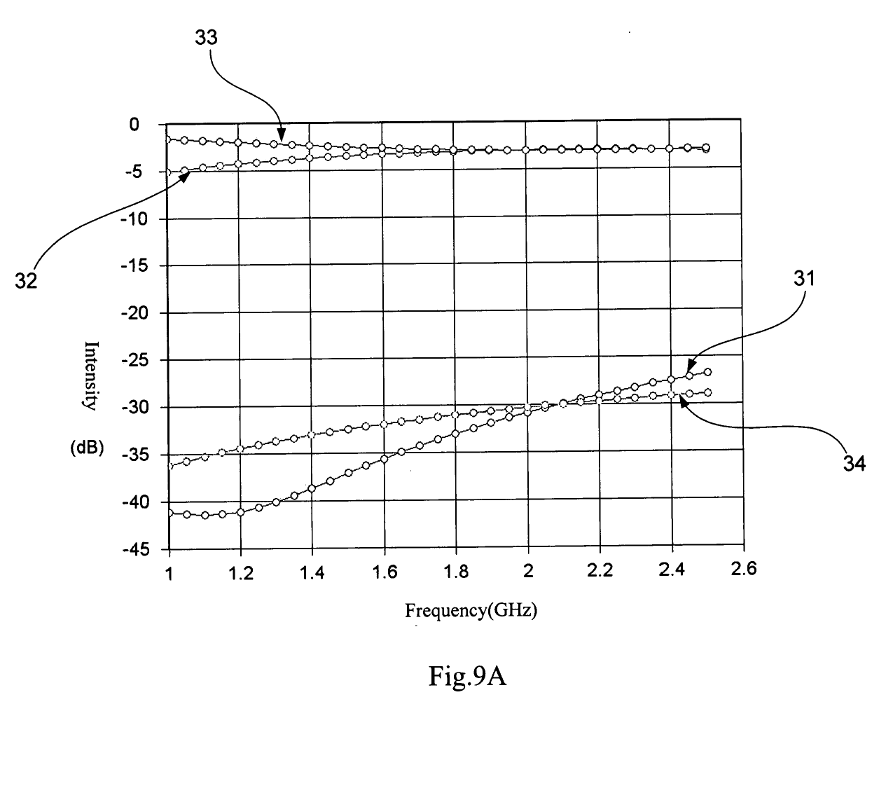

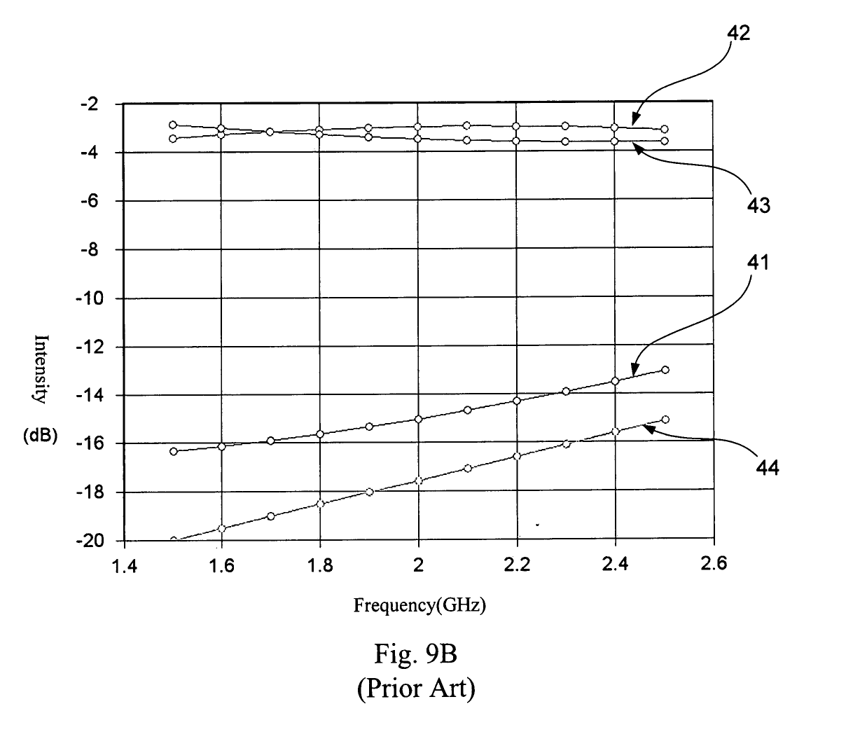

Please refer to FIGS. 9A and 9B of schematic diagrams showing S-parameter curves of coupling devices according to the present invention and prior art, respectively. Both coupling devices have in put end, a coupling end, an output end, and an isolation end. The coupling device according to the present invention has a first, second, third, and fourth curves 31, 32, 33, and 34 while its counterpart based on the prior art is with fifth, sixth, seventh, and eighth curves 41, 42, 43, and 44.

The second and third curves are from the coupling and output ends of the coupling device according to the present invention. From those two curves, the amount of coupling effect and output is substantially equal at the frequency of 2 GHz while their counterparts (the sixth and seventh curves 42 and 43 from coupling and output ends of the coupling device of the prior art) are not close to each other at the same 2 GHz frequency, failing to meet the goal of having the amount of the coupling effect and output substantially equal.
The first and fifth curves show inputs of coupling devices according to the present invention and prior art. At the frequency of 2 GHz, the return loss for the coupling device according to the present invention is minus 32 db but is minus 15 db in the case of the coupling device based on the prior art. As the result, the present coupling device does improve the return loss.
   The fourth and eighth curves 34 and 44 come from isolation ends of coupling devices according to the present invention and prior art, respectively. At the frequency of 2 GHz, the amount of isolation capacity is minus 31 db in the coupling device according to the present invention while the coupling device according to the prior art has the isolation capacity stay at minus 17.5 db. Above two curves show the difference in the isolation capacity between the coupling device according to the prior art and present invention, which effectively improve the performance of the isolation capacity.
   In contrast to prior art coupling device, the coupling device according to the present invention incorporates a parallel-connected capacitor device to the ground for improving the return loss and isolation capacity and making the coupling effect and the amount of output reach to a level as expected. With the aforementioned characteristic, the present invention makes transmitting speeds in the first and second signal lines remain substantially the same so as to achieve better high frequency characteristics.
   Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A coupling device with electro-magnetic compensation, comprising:
a first substrate having a first signal line on a top surface of the first substrate; and
a second substrate having a second signal line on a top surface of the second substrate connected together with a bottom surface of the first substrate;
wherein the second signal line couples with the first signal line by a plurality of electrical-conductive through holes;
wherein one side of the first signal line lies a capacitor device parallel connected to a ground.

2. The coupling device with electro-magnetic compensation in claim 1, wherein the bottom surface of the second substrate connects to a multi-layer substrate and each layer of the multi-layer substrate is with a circuitry layout individually.

3. The coupling device with electro-magnetic compensation in claim 1, wherein the capacitor device parallel connected to the ground is an open stub.

4. The coupling device with electro-magnetic compensation in claim 1, wherein the capacitor device parallel connected to the ground is in the form of a plurality of open stubs connected with others through wire bonding.

5. The coupling device with electro-magnetic compensation in claim 1, wherein the capacitor device parallel connected to the ground is in the form of a plurality of open stubs connected with others through ribbon bonding.

6. The coupling device with electro-magnetic compensation in claim 1, wherein the capacitor device parallel connected to the ground is in the form of having at least one capacitor electrically connected to an electrically grounded open stub.

7. The coupling device with electro-magnetic compensation in claim 6, wherein the electrically grounded open stub is with at least one through hole so as to electrically connect to the ground.

8. A coupling device with electro-magnetic compensation, comprising:
a first substrate having a first signal line on a top surface of the first substrate; and
a second substrate having a second signal line on a top surface of the second substrate connected together with a bottom surface of the first substrate
wherein the second signal line is coupled in the form of a plurality of electrical-conductive through holes;
wherein the first signal line lies a first capacitor device parallel connected to the ground on one side thereof and a second capacitor device parallel connected to the ground on the other side of the first signal line.

9. The coupling device with electro-magnetic compensation in claim 8, wherein the bottom surface of the second substrate connects to a multi-layer substrate and each layer of the multi-layer substrate is with a circuitry layout individually.

10. The coupling device with electro-magnetic compensation in claim 8, wherein the first capacitor device parallel connected to the ground is an open stub.

11. The coupling device with electro-magnetic compensation in claim 8, wherein the second capacitor device parallel connected to the ground is an open stub.

12. The coupling device with electro-magnetic compensation in claim 8, wherein the first capacitor device parallel connected to the ground is in the form of having at least one capacitor electrically connected to a grounded open stub.

13. The coupling device with electro-magnetic compensation in claim 12, wherein the grounded open stub is with at least one through hole in order to electrically connect to the ground.

14. The coupling device with electro-magnetic compensation in claim 8, wherein the second capacitor device is in the form of having at least one capacitor electrically connected to a grounded open stub.

15. The coupling device with electro-magnetic compensation in claim 14, wherein the grounded open stub is with at least one through hole in order to electrically connect to the ground.

16. The coupling device with electro-magnetic compensation in claim 8, wherein the first capacitor device parallel connected to the ground is in the form of a plurality of open stubs connected with others through wire bonding.

17. The coupling device with electro-magnetic compensation in claim 8, wherein the first capacitor device parallel connected to the ground is in the form of a plurality open stubs connected with others through ribbon bonding.

18. The coupling device with electro-magnetic compensation in claim 8, wherein the second capacitor device parallel connected to the ground is in the form of a plurality of open stubs connected with others through wire bonding.

19. The coupling device with electro-magnetic compensation in claim 8, wherein the second capacitor device parallel connected to the ground is in the form of a plurality of open stubs connected with others through ribbon bonding.
